(19) United States
(12) Patent Application Publication
(10) Pub. No.: US 2026/0147549 A1
(43) Pub. Date: May 28, 2026

(54) APPARATUS AND METHOD FOR UNCERTAINTY-AWARE CODE GENERATION USING LARGE LANGUAGE MODELS (LLMS)

(71) Applicant: Intel Corporation, Santa Clara, CA (US)

(72) Inventors: Athmanarayanan Lakshmi Narayana, Sunnyvale, CA (US); Ranganath Krishnan, Hillsboro, OR (US); Mahesh Subedar, Folsom, OR (US); Omesh Tickoo, Portland, OR (US)

(73) Assignee: Intel Corporation, Santa Clara, CA (US)

(21) Appl. No.: 19/447,995

(22) Filed: Jan. 13, 2026

(51) Int. Cl. G06F 8/35

(52) U.S. Cl. CPC G06F 8/35

(57) ABSTRACT

Apparatus and method for uncertainty-aware code generation using LLMs. For example, one embodiment of a method comprises: generating, by a large language model (LLM) code generator, a plurality of RTL code blocks based on a design prompt; determining syntactical similarities and semantic similarities between pairs of the RTL code blocks; arranging the RTL code blocks into a plurality of clusters based on a combination of the syntactical similarities and the semantic similarities; generating uncertainty estimates indicating levels of uncertainty associated with one or more clusters of the plurality of clusters; and determining whether to synthesize an RTL output using one or more of the RTL code blocks based on the uncertainty estimates.

### BACKGROUND

### Field of the Invention

This invention relates generally to the field of processors. More particularly, the invention relates to an apparatus and method for uncertainty-aware code generation using large language models (LLMs).

### Description of the Related Art

As enterprises increasingly adopt large language models (LLMs) to generate and modify production code within large-scale software systems, concerns about code quality and reliability have become more urgent. Microsoft, for example, reports that 20%-30% of the code in some projects is now written by artificial intelligence (AI) engines. In the silicon industry, agentic LLMs are being used to address AI-driven hardware design challenges with minimal human intervention. Synopsys is introducing agentic AI electronic design automation (EDA) workflows and expects to save approximately 250,000 internal development man-hours over the past year.

However, LLMs are prone to hallucinations—generating syntactically valid but semantically incorrect or misleading code—which can be disastrous in complex systems. Such errors often go undetected when the code generated appears functional or passes partial tests but fails during full system integration. In agentic environments, where LLMs iteratively interact with tools and simulators, waiting for post-simulation failure feedback can introduce significant delays in debugging man-hours and wasted compute cycles.

### BRIEF DESCRIPTION OF THE DRAWINGS

A better understanding of the present invention can be obtained from the following detailed description in conjunction with the following drawings, in which:

FIG. 1 illustrates an example LLM code generator architecture in which embodiments of this disclosure may be implemented.

FIG. 2 illustrates an example embodiment with semantic clustering and semantic uncertainty quantification (UQ).

FIG. 3 illustrates an example embodiment with functional clustering and functional uncertainty quantification (UQ).

FIG. 4 illustrates an example embodiment with clustering based on both functional and semantic assessment and uncertainty quantification (UQ).

FIG. 5 illustrates an example including a prompt to determine whether two code blocks are semantically and syntactically similar or equivalent.

FIG. 6 illustrates test results contrasting different embodiments of this disclosure to prior implementations.

FIG. 7 illustrates test results using different embodiments of this disclosure individually and in combination.

FIG. 8 illustrates an example in which a failure is evaluated by a designer following register-transfer level (RTL) synthesis.

FIG. 9 illustrates an example embodiment in which uncertainties in code are evaluated by a designer prior to RTL synthesis.

FIG. 10 illustrates a method in accordance with some embodiments of this disclosure.

FIG. 11 illustrates an example system including an accelerator and a host processor.

### DETAILED DESCRIPTION

A semantic uncertainty framework in accordance with embodiments of this disclosure provides robust hallucination detection in large language model (LLM)-assisted code generation. The semantic uncertainty framework aggregates a plurality of generated samples into meaningful uncertainty metrics that go beyond conventional token-level or purely semantic approaches.

As used herein, the “syntactic” similarity between two code blocks is a measure of how much the two code blocks look the same with respect to text and code structure, the “semantic” similarity refers to a measure of the extent to which the two code blocks share the same meaning, intent, or concept, and the “functional” similarity is a measure of whether the two code blocks yield the same output (including error conditions) in response to the same input. Thus, functional similarity may be considered a specific instance of semantic similarity.

By connecting uncertainty to the syntactic, functional, and semantic aspects of code, embodiments of this disclosure provide a comprehensive and accurate detection mechanism which is model agnostic and applicable ad-hoc to any open or closed source language mode (e.g., high-level languages such as Python and C++, and hardware description languages such as RTL). The uncertainty metrics described herein also support agentic design workflows to detect hallucinations in register-transfer level (RTL) code and efficiently identify the correct outputs. These implementations ensure both compilation and functional correctness of generated code, producing synthesizable RTL, and enhancing the robustness and reliability of AI-driven code generation systems.

Uncertainty-aware code generation, as described herein, early identification of functionally divergent or potentially erroneous code snippets. Agentic workflows can then preemptively prioritize high-confidence generations and flag low confidence outputs for targeted review, accelerating the feedback loop and calibrating trust in the underlying model. These implementations can also highlight the limitations of LLMs currently used in these workflows, paving the way for adaptive sampling, model improvement, and robust toolchain integration.

Unlike traditional token- or sentence-level entropy measures, embodiments of this disclosure leverage multiple samples to ensure a more robust and calibrated uncertainty estimation. While existing semantic entropy methods focus on capturing the meaning of natural language outputs, the techniques described herein are specifically adapted for code generation, leveraging complementary strategies to measure similarity and population disagreement, including: (1) syntactic similarity, (2) functional equivalence, and (3) a combined approach using a code judge to capture semantic meaning. These techniques enable effective uncertainty estimation while requiring fewer samples and integrate seamlessly into developed agentic RTL workflow, which incorporates iterative feedback from compilers and linting tools.

As used herein, “semantic entropy” measures the uncertainty of an LLM by focusing on the meaning of its outputs rather than just the specific words used to express the meaning. In contrast to standard entropy, which may subdivide the overall probability across alternatively-worded responses having the same meaning, semantic entropy ignores the wording differences and focuses on the underlying information. If all the model's generated answers mean the same thing, the semantic entropy is low (high confidence). If the generated answers contain conflicting facts, the semantic entropy is high (low confidence/hallucination).

In accordance with some implementations, semantic entropy is determined as follows, given an input context x and possible output sequences, represented by a series of tokens (t₁, t₂ . . . , tₙ), the probability of the sequence is given as:

$$p ( s \vert x ) = {\prod }_{i = 1}^{n} p ( {t}_{i} \vert {t}_{1 : i - 1} , x )$$

The generated sequences are then grouped into semantic clusters C, where each cluster contains outputs that convey the same underlying meaning. In natural language, this is relatively straightforward. For example, “dog” and “canine” would belong to the same cluster.

In the context of code generation, however, defining such clusters is far more challenging. In some embodiments described herein, code is clustered in a way that preserves semantic equivalence, enabling meaningful estimation of the code uncertainty. Once these clusters are defined, the probability of a cluster is defined as:

$$p ( C \vert x ) = {\sum }_{s ∈ C} p ( s \vert x )$$

Semantic entropy may be computed as Shannon entropy, which is the expectation over the probability of clusters:

$$H [ C \vert x ] = {E}_{p ( C \vert x )} [ - log p ( C \vert x ) ]$$

When a probability distribution is peaked—meaning one event is almost certain—the average surprise is low, which corresponds to low entropy and low uncertainty. When the distribution is spread out—with many events having similar probabilities—the average surprise is high, leading to high entropy and high uncertainty. In code generation, high uncertainty can manifest as hallucinations. The model is less confident about which output is correct, which increases the likelihood of errors in the generated code.

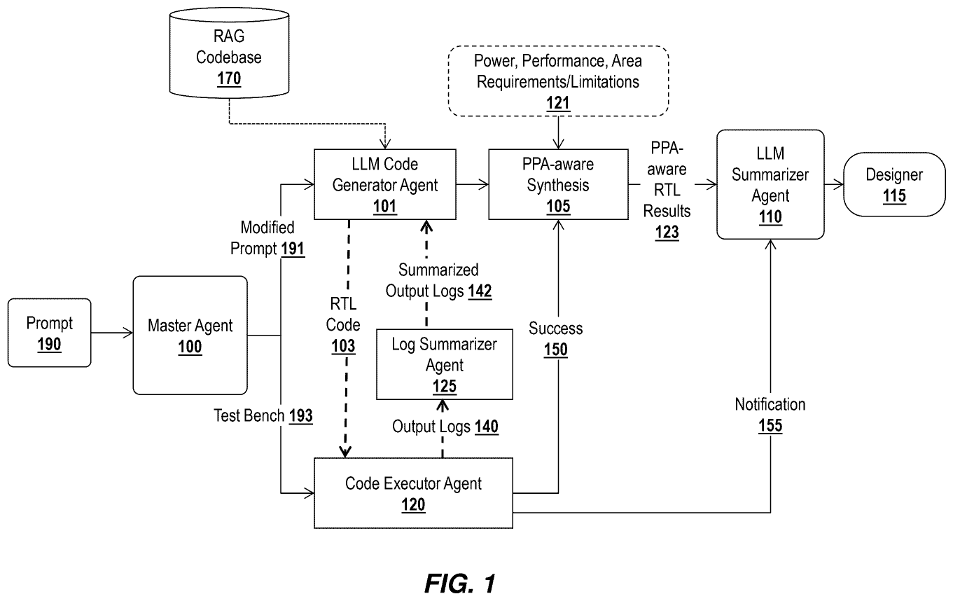

In some implementations, complementary clustering techniques are used which capture different aspects of code generation. For example, a specified number of samples (e.g., n=5, n=10, etc.) for each problem. In these implementations, the user inputs a prompt and multiple test cases (if available) directly to a code generation LLM. Thus, for example, n=5 or n=10 samples may be captured from the LLM generation to generate code or perform specification to code operations (e.g., natural language to code translation). The generated code is then clustered based on the code meaning. FIGS. 1-3 illustrate three example embodiments, one of which may be selected based on different scenarios and test bench availability.

### LLM-Based RTL Code Generation

Some embodiments of this disclosure operate within an agentic framework for automated RTL code generation in which agents iteratively refine code with progressive error feedback to ensure both compilation and functional correctness with synthesizable RTL constructs. The progressive error feedback mechanism guides LLM agents to focus on relevant error messages. These techniques prevent token and context overload, reduce the risk of hallucinations, and improve code refinement efficiency.

Some embodiments of the agentic system automate the iterative process of RTL design by evaluating both the design prompt and test bench. The design prompt, for example, can include user-provided data that indicates the desired behavior of the hardware design (e.g., at the register-transfer level (RTL)) and the test bench can include program code generated to verify the functionality of the hardware design (e.g., written in a hardware description language (HDL) representation or module).

In some implementations, custom agents interact with LLMs via API calls (e.g., configured on top of the agentic framework). The custom agents operate in a state-driven workflow, where each agent's output determines the next operation, thereby providing coordinated, stepwise refinement of the RTL code. The system evaluates test results at each step and updates the design prompt or logic accordingly until the RTL code passes all tests, thereby streamlining RTL code generation.

FIG. 1 illustrates an example architecture in which a master agent 100 is programmatically tasked with parsing and extracting relevant data from a design prompt 190 and corresponding test bench 192. In the illustrated example, the extracted data is represented with a modified design prompt 191 and modified test bench 193, respectively. As mentioned, the design prompt 190 may comprise a textual or user-provided input data that defines the hardware design at the Register-Transfer Level (RTL)) and the test bench 192 may comprise a hardware description languages (HDL) representation or software module designed to test and verify the functionality of the hardware design.

Context or system messages are provided to the LLM code generator agent 101 in modified design prompt 191, directing the LLM code generator agent 101 to produce RTL code 103, which is subsequently executed by the code executor agent 120 as described herein. The test bench 192 may be programmatically modified in accordance with a template to generate the modified test bench 193 (e.g., to include the $monitor command to track input/output signal changes along with the value change dump (VCD) file).

In some implementations, the master agent 100 is a group manger, grouping the input text of the design prompt 190 into text related to RTL code (e.g., included in modified design prompt 191) and text related to test bench code (e.g., included in modified test bench 193). For example, the master agent 100 may convert the input design prompt 190 into a chain-of-thought prompt in modified design prompt 191 to plan the overall execution flow. The master agent 100 directs the modified design prompt 191 to the LLM code generator agent 101, which leverages the LLM in the backend to convert the modified prompt 191 into RTL code 103 to be executed by a code executor module 120. In some implementations, the LLM code generator agent 101 converts the modified prompt 191 in a zero-shot manner (e.g., without being specifically trained for the task of converting prompts into RTL code). Additionally, the LLM code generator agent 101 can optionally leverage a Retrieval-Augmented Generation (RAG) codebase 101 (e.g., a Verilog codebase in some implementations) to calibrate its responses within the relevant context.

The master agent 100 may generate the modified test bench 193 to include one or more commands to track input/output signal changes (e.g., via the $monitor command to print input/output signal changes) and to indicate one or more change files to record changes in values of signals and variables during a simulation. In some implementations, this includes a template-based value change dump (VCD) file generated during RTL code execution by the code executor agent 120. These change files may be generated by one or more Electronic Design Automation (EDA) tools during the simulation of the HDL design via the code executor agent 120 to provide a detailed analysis of signal waveforms and variable states over time, which is crucial for debugging and verifying the behavior of the hardware design.

This approach is notably more informative than standard test bench implementations which only report mismatches or indicate compilation success. The modified test bench 193 is communicated to the code executor agent 120, which may store it in a file or as a data structure in memory for subsequent operations. The code executor agent 120 or LLM code generator agent 101 initially performs a compilation verification on the RTL code (i.e., to ensure it will properly compile) and, once verified, compiles the RTL code for execution by the code executor agent 120 in accordance with the modified test bench 193 (e.g., using Icarus Verilog (iverilog)).

The code executor agent generates output logs 140 to indicate execution results, including any errors generated during execution such as mismatches between expected results and actual results. For example, when running the RTL code 103 on the modified test bench 193, the code executor agent 120 may compare generated output values with corresponding expected output values and generate indications in the output logs 140 mismatches are detected (e.g., when expected output values do not match the generated output values). In some embodiments, the code executor agent 120 runs in a virtual machine or other virtualized execution environment and implements a rule-based agent architecture to execute the RTL code 103 in accordance with the modified test bench 193.

Following execution of the RTL code 103 (or when a threshold number of mismatches or other errors have been detected), the output logs 140 indicating the errors and other results are parsed by a log summarizer agent 125 which extracts the relevant data to summarized output logs 142 (e.g., filtering out unnecessary data and/or aggregating results).

In some implementations, the LLM code generator agent 101 evaluates the summarized output logs 142 to implement targeted changes to the RTL code 103, with the goal of eliminating the errors. Following the changes, the modified RTL code 103 is compiled and executed by the code executor agent 120 in a second iteration in accordance with the modified test bench 193. This process repeats until the compiled RTL code is error-free or until a threshold number of iterations has been reached. Each time a new error is detected in an iteration, the error is recorded in the output logs 140, 142 and evaluated by the LLM code generator agent 101 to make additional targeted modifications to the RTL code 103.

In some embodiments, the process terminates and a notification is sent to the designer 115 when a threshold number of iterations is reached. For example, in one embodiment, the number of compile attempts and executions by the code executor agent 120 are counted until a threshold value (N) is reached (e.g., N=4). On the first attempted compilation of the RTL code 103 (by the LLM code generator agent 101 or code executor agent 120), a counter is set to 1 (i.e., N=1) and is incremented for each subsequent compilation attempt (if any) and for each execution of a new instance of the RTL code 103 based on the modified test bench 193. If the counter value, N, reaches the threshold, then the process terminates and a notification 155 is sent to the designer 115 to indicate that user intervention is needed. For example, if N=4 and the RTL code 103 was successfully compiled in two attempts, then the code execution agent 120 will have two chances to successfully execute the RTL code 103 with no errors before the designer 115 is sent the notification 155.

When the code executor agent 120 successfully executes the RTL code 103 without errors, a success indication 150 is generated to indicate that the RTL code 103 is reliable. In some implementations, the resulting RTL code 103 is sent to a power, performance, area (PPA)-aware synthesis agent 105 which evaluates and further refines the RTL code in view of specified power, performance, and area requirements/limitations 121. For example, if the hardware represented in the RTL code is intended for use in a mobile device, then the PPA-aware synthesis agent 105 may generate RTL code results 123 designed for high-efficiency, reduced power operation while maintaining an acceptable level of performance and consuming a reasonable amount of chip area. Conversely, if the hardware is intended for use in a workstation or server, the PPA-aware synthesis agent 105 may generate RTL code results 123 weighted towards the highest achievable performance, given the maximum power and silicon area requirements. More generally, the PPA requirements/limitations 121 may indicate minimum and maximum values for power, performance, and area, which the PPA-aware synthesis agent 105 uses to generate the RTL code results 123 in accordance with the intended use of the hardware.

The PPA-aware RTL results 123 are provided to an LLM summarizer agent 110 which parses and organizes information for review by a designer 115. For example, in addition to the final RTL code configured in accordance with PPA requirements/limitations, the LLM summarizer agent 110 generates a report indicating the success or failure of the attempted code generation including a summary of the entire transaction history. In these implementations, the summary can include information related to one or more of: failed compilations, errors in each attempted execution, the PPA settings, test bench modifications, and/or changes to the RTL code made by the LLM code generator agent 101 for each iteration. The LLM summarizer agent 110 may operate similarly to the log summarizer agent 125 but operates on a larger set of transactions.

The agentic system described herein provides a coherent platform for LLM-based RTL code generation with context-based information a designer 115 can use for performing additional modifications to the RTL code. These implementations provide for minimal intervention by the designer 115, as the summarized output of the entire sequence of transactions provide insights into the progress of the LLM code generator agent 101, ensuring that the LLM code generator agent 101 adheres to the initial instructions and avoids hallucinations. Upon review, the designer 115 may determine whether the results are acceptable or whether an intervention is needed.

### Uncertainty-Aware Code Generation

The embodiments of this disclosure include a semantic uncertainty framework for robust hallucination detection in LLM-assisted code generation. Unlike prior implementations which focus on token-level probability estimates or semantic similarity alone, these embodiments aggregate multiple generated samples into structured uncertainty metrics that explicitly connect to the syntactic, functional, and/or semantic properties of the generated code.

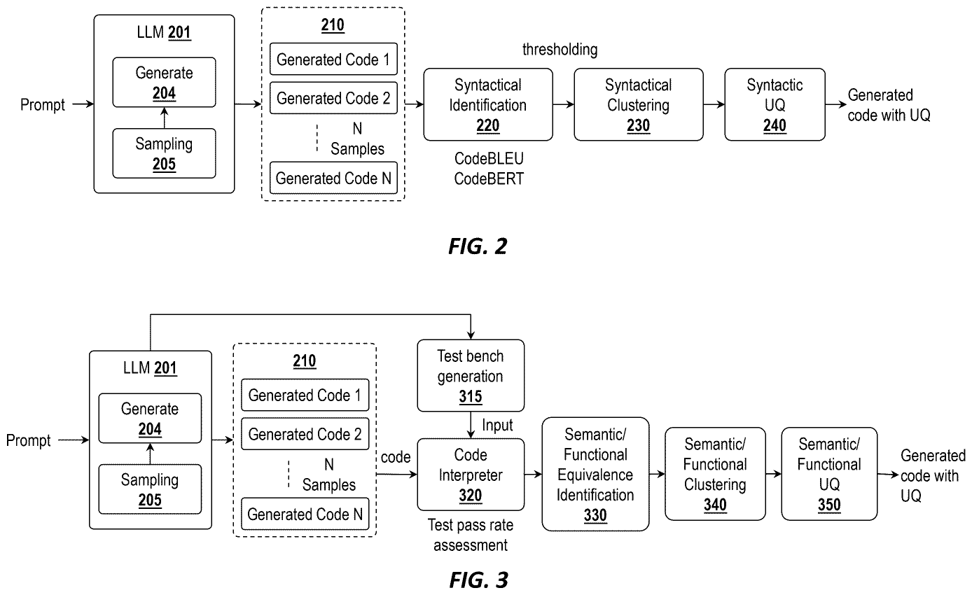

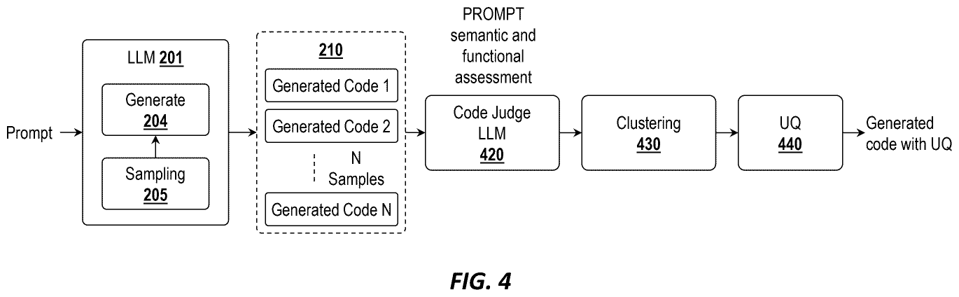

Examples of a semantic, syntactic, and functional entropy estimation workflow will be described with respect to FIGS. 2-4, which illustrate an LLM 201 which performs sampling 205 and code generation 204 as described herein. In these embodiments, the LLM 201 (the LLM code generator agent 101 in FIG. 1) generates a number, N, of code samples 210 which are evaluated and clustered based on respective similarities. These embodiments leverage the complementary approaches of: (1) syntactic similarity, as described with respect to FIG. 2, implemented via techniques such as CodeBLEU and CodeBERT to evaluate the structural similarity between code samples; (2) functional equivalence, as described with respect to FIG. 3, determined via test case-code samples that pass the same tests and produce the same errors (i.e., making them functionally equivalent); and (3) a combined syntactic, semantic, and functional assessment, as described with respect to FIG. 4, which leverages a fine-tuned code judge model prompted to jointly capture semantic meaning, syntactic, and functional behavior. Note that the terms “code samples,” “code snippets,” and “code blocks” are used interchangeably herein when referring to the discrete code sequences generated by the LLM 201.

With respect to syntactical similarity, the generated code samples 210 are evaluated by syntactical identification logic 220 to indicate similarities between the code samples. Two code snippets are considered syntactically similar if they look the same—i.e., share the same or similar text and code structure. To quantify this, the semantic identification logic 220 may generate a similarity score (SC) between each pair of code samples. In some embodiments, this is done using n-gram matching with abstract syntax trees (ASTs) for comparing code structures (see, e.g., “CodeBLEU: a Method for Automatic Evaluation of Code Synthesis” (Ren et al., 2020)) and using a pretrained model fined tuned for code clone detection (see, e.g., “Generalizability of code clone detection on CodeBERT.” Proceedings of the 37th IEEE/ACM international conference on automated software engineering (2022)).

Formally, the syntactic similarity score for a pair of code snippets, (cᵢ, cⱼ) is defined as:

$$SC ( {c}_{i} , {c}_{j} ) = \frac{BLEU ( {c}_{i} , {c}_{j} ) + CodeBLEU ( {c}_{i} , {c}_{j} ) + CodeBERT ( {c}_{i} , {c}_{j} )}{3}$$

and the empirical threshold t is set such that:

$$similar ( {c}_{i} , {c}_{j} ) = \{ \begin{matrix}True , & if SC ( {c}_{i} , {c}_{j} ) > τ \\ False , & otherwise\end{matrix}$$

For n code snippets (e.g., where n=5 or n=10) all pairwise similarities are computed to produce a similarity matrix that is used for clustering.

Based on the similarity scores, syntactic clustering logic 230 generates clusters of generated code samples. Syntactic uncertainty quantification logic 240 then quantifies the amount of uncertainty between the code sample clusters.

Referring to FIG. 3, because syntactic similarity alone cannot capture the semantic equivalence of generated code, manually designed test benches may be used, as indicated by test cases generation logic 315 provided as input to a code interpreter 320 which emulates the execution of the code samples 210 with selected inputs to generate respective outputs. Semantic/functional equivalence identification logic 330 determines the semantic/functional similarity of each pair of code blocks based on the extent to which the code blocks yield the same output for the same input and respond to errors in the same manner. Semantic/functional clustering logic 340 forms clusters of the code blocks based on the detected semantic/functional similarity and semantic/functional uncertainty quantification (UQ) logic 350 quantifies the amount of uncertainty between the clusters of code samples.

Code samples which are functionally equivalent should produce the same output and the same errors when tested on a test bench. More formally, let T={t₁, t₂, . . . , tₘ} be the test cases and let R(cᵢ, tₖ) denote the binary result of running code snippet cᵢ on test case tₖ. Each cᵢ is executed against all tₖ to produce a result vector rᵢ∈{0,1}^{m} where 1 denotes passing the testcase and zero denotes failing the testcase. For two code samples created, cᵢ, and cⱼ, if n=r), the code samples are considered sufficiently similar or functionally equivalent. If the code samples produce a compilation error or produce an error for failing testcases, the error types are categorized (e.g., Index Error, Name Error, Value Error) and a category ID is assigned. Codes samples that produce the same category identifications on all the test cases are clustered by semantic/functional clustering logic 340. Hence, clustering captures semantic behavior, grouping code by execution outcome rather than syntax alone.

Referring to FIG. 4, to address both types of similarities at the same time, especially in cases when test cases do not exist, one or more Judge LLMs 420 perform the role of judging the output of the code-generating LLMs 201 using relatively smaller language models (e.g., LLM models of sub-8B parameters). These judging models are evaluated with appropriate templates that measure semantic (including functional) and syntactic similarity between two code snippets. This provides the opportunity to perform automated evaluation of similarity which would otherwise have relied completely on execution-based testing. Clustering logic 430 then forms clusters of the code samples based on the measured functional and syntactic similarity. Uncertainty quantification (UQ) logic 440 determines the level of uncertainty between the clusters.

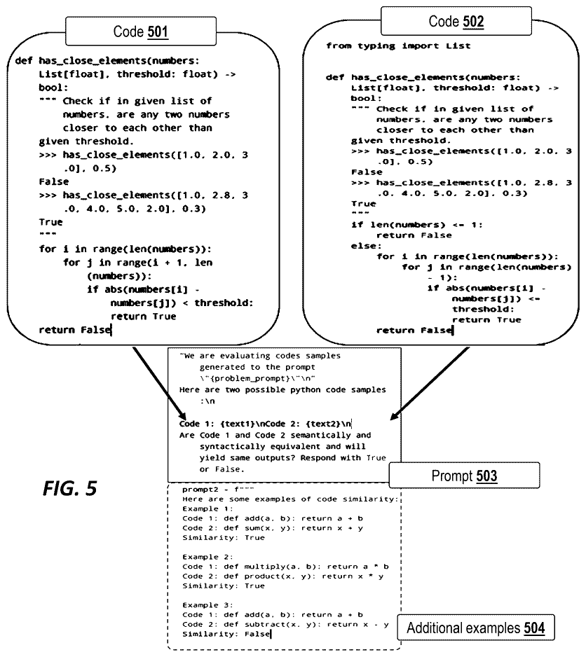

FIG. 5 illustrates an example prompt 503 to compare a pair of code blocks 501-502 based on semantic (e.g., functional) and syntactic similarity. In a specific implementation, the prompt 503 is used for Llama-3.1 (8B) and Qwen 2.5 Coder (7B), although the underlying principles of this disclosure are not limited to any particular type or family of LLMs. In operation, the code judge LLM 420 determines the functional and syntactic similarity for each pair of generated samples 501-502. In some implementations, a similarity matrix is constructed with these similarity measurements and is then used to cluster the code blocks by clustering logic 430. The two code blocks 501-502 may be inserted in a prompt template and the similarity result, e.g., “True” or “False,” may be used to cluster the samples.

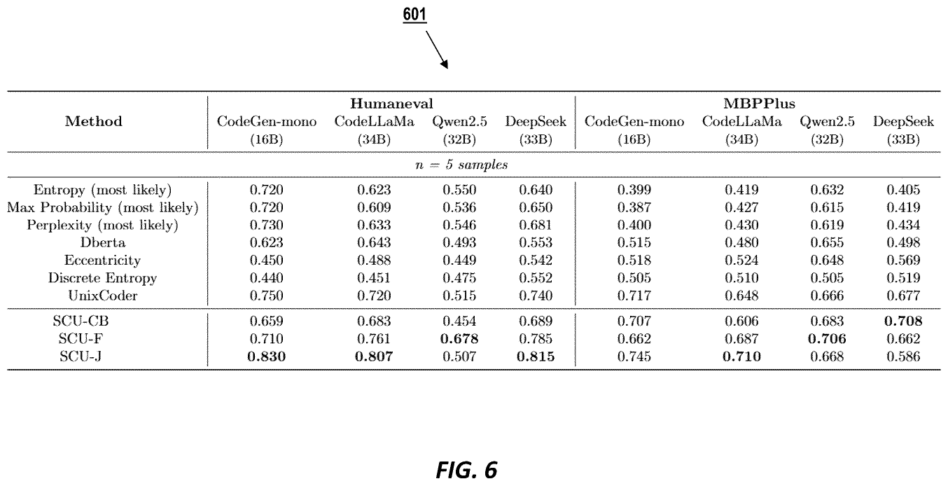

The table 601 in FIG. 6 provides results for different embodiments of the semantic code uncertainty (SCU) framework described herein using publicly available benchmarks for code generation. SCU-CB measures syntactic similarity as described with respect to FIG. 2 (e.g., via CodeBLEU, BLEU, and CodeBERT). SCU-F measures functional similarity as determined from the execution outcomes of test cases, as described with respect to FIG. 3. SCU-J uses a code judge approach as described with respect to FIG. 4, in which an LLM evaluates the similarity between code snippets. While Qwen 2.5-7B is used as the primary judge in some implementations, various other models may instead be used (e.g., LLAMA 3.1). Table 601 provides a comparative evaluation of uncertainty quantification performance on two benchmark datasets: HumanEval and MBPP+. The evaluation includes baseline uncertainty metrics (e.g., entropy, perplexity, max probability), learned similarity measures (e.g., UnixCoder, Dberta, SCU-CB), and functional correctness signals (e.g., CodeJudge, Functional).

To determine the final uncertainty quantification, uncertainty scores are paired with binary correctness labels, where samples that passed functional evaluation were assigned a label of 1 and failures a label of 0. The implementations in accordance with the present disclosure outperform both single-sample methods (n=1) and other multi-sample approaches (n=5) that rely on large language models for entailment.

For evaluation, the Area Under the Receiver Operating Characteristic (AUROC) is defined as:

$$AUROC = {\int }_{0}^{1} TPR ( FPR - 1 ( x ) ) dx ,$$

where TPR denotes the true positive rate and FPR the false positive rate, with positives defined as generated code that passes all test cases (y=1) and negatives as code that fails all test cases (y=0). A higher AUROC indicates a greater ability to detect uncertain generations that either fail compilation or fail to meet functional correctness.

In some implementations, each LLM-generated code sample is compiled and executed against the dataset-provided test cases to determine execution outcomes. For each prompt, n=5 candidate programs are produced using high-temperature sampling (temperature=0.9). From these samples, a range of uncertainty metrics are computed, including mean token-level entropy (sentence entropy):

$${H}_{mean} = \frac{1}{T} {\sum }_{t = 1}^{T} [ - {\sum }_{v ∈ V} {p}_{t} ( v ) log {p}_{t} ( v ) ]$$

where T is the total number of tokens in sequence, V is the vocabulary and pₜ(v) is the predicted probability of token v at position t. The maximum probability of the token is defined as:

$${p}_{max} = \frac{1}{T} {\sum }_{t = 1}^{T} max ( {p}_{t} ( v ) ) ,$$

In addition, perplexity, eccentricity, and discrete entropy may be measured. For semantic-based evaluation, semantic entropy is determined using both DeBERTa and a UnixCoder code-specific entailment model for clustering, which serve as the major baselines.

Overall, the semantic code uncertainty (SCU) techniques achieve state-of-the-art performance, with strong results across both benchmarks and multiple generation models. Notably, the SCU-F and SCU-J variants are threshold-free, making them particularly attractive in scenarios where manual threshold tuning is impractical or time-consuming.

While each of the techniques described herein can independently capture uncertainty, the combined uncertainty quantification (UQ) used in certain implementations leverages the strengths of all approaches to comprehensively assess code generation quality. In some embodiments, two code snippets, cᵢ and cⱼ, are clustered as similar if all of the techniques classify them as equivalent. This ensures that agreement in any dimension of uncertainty (structural, functional, or semantic) is preserved.

In cases where there is disagreement among multiple uncertainty quantification techniques, a rule-based operations may be performed to determine the final clustering decision. For example, the syntactic similarity may first be determined between two code snippets, cᵢ and cⱼ (e.g., as the sum of their BLEU, CodeBLEU, and CodeBERT scores). If this combined syntactic similarity exceeds a predefined threshold τscore, and the code snippets are judged to be functionally similar by either the functional equivalence identification logic 330 (e.g., SCU-F) or the code judge LLM 420 (e.g., SCU-J), they are classified as similar and assigned to the same cluster. Otherwise, the code snippets are considered dissimilar and placed in separate clusters. These embodiments ensure that syntactic resemblance is always supported by at least one reliable measure of functional equivalence, providing a balanced and robust decision process when the primary methods disagree.

The following similarity equation illustrates the logic involved in at least one of the above embodiments:

$$similar ( {c}_{i} , {c}_{j} ) = \{ \begin{matrix}True , & if BLEU ( {c}_{i} , {c}_{j} ) + CodeBLEU ( {c}_{i} , {c}_{j} ) + CodeBERT ( {c}_{i} , {c}_{j} ) > τ score and ( SCU - F \vert SCU - J = 1 ) \\ False , & otherwise\end{matrix}$$

This hierarchical integration ensures that the combined system is both inclusive in detecting potential matches and precise when ambiguity arises, capturing a broader and more accurate picture of code hallucination risk.

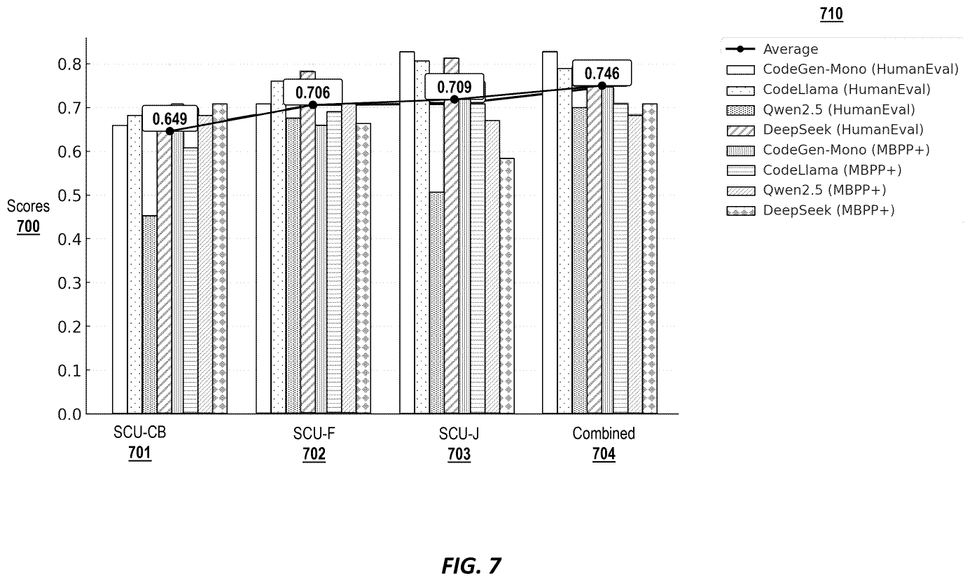

FIG. 7 illustrates results of the combined UQ system, including results using syntactic identification logic 220 and clustering 230 (SCU-CB model 701), functional equivalence identification logic 330 (SCU-F model 702), and the code judge LLM 420 and clustering 430 (SCU-J model 703) for agreement and disagreement. As illustrated, the combined results 704 outperform the individual techniques. Thus, when applied to the HumanEval and MBPP+datasets 701, as described above, and averaging the results across both datasets and models, the combined system 704 achieves state-of-the-art performance, with an average AUROC score of 0.746, demonstrating robustness across datasets and models.

The combined system need not incorporate all UQ modules; for example, in the absence of clear or available testbenches, only the syntactical identification 220 and code judge LLM 420 may be used, with the equation adjusted accordingly (e.g., SJ-CB and SJ-J).

While some implementations presented herein use Python as a proof of concept, the underlying principles of this disclosure are readily extensible to any programming language, such as Java, C, C++, and RTL code for hardware design. Some RTL embodiments may include appropriate test benches 315 for the RTL code and/or the code judge LLM models 420 may be fine-tuned on RTL datasets to compare pairs of RTL designs for similarity. Thus, the embodiments of this disclosure are broadly applicable to diverse programming languages with only minor, ad hoc modifications.

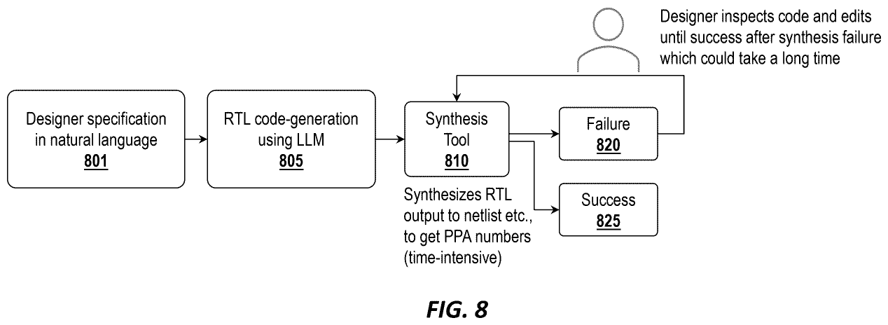

Referring to FIG. 8, in an agentic hardware design pipeline, the user provides design specifications 801 to an LLM-based code generator 805 which generates RTL code from the natural language specification. The generated RTL code is then passed to a synthesis tool 810, to produce a gate-level netlist and corresponding power, performance, and area (PPA) metrics (e.g., PPA metrics 123 in FIG. 1).

A key challenge is that synthesis by the synthesis tool 810 is typically time-consuming (sometimes taking days). If the RTL code generated by the LLM 805 is partially or fully hallucinated (containing subtle or hidden errors), then even if it compiles successfully, it has a high likelihood of failing 820 during synthesis or producing incorrect outputs. In such cases, the designer must manually inspect and debug the code after each synthesis iteration until a success 825.

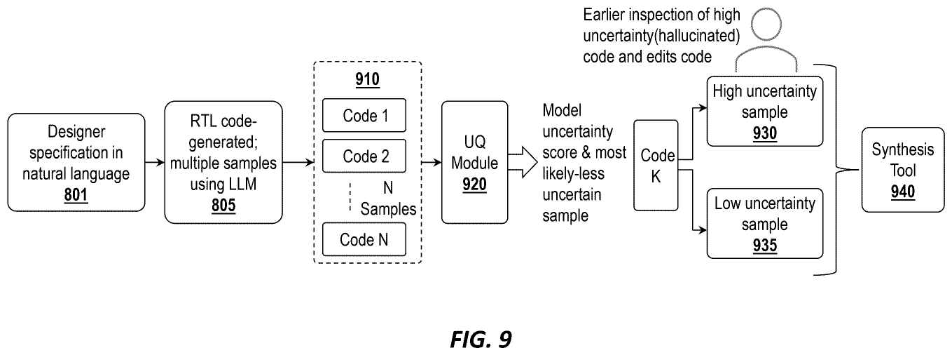

In contrast, FIG. 9 illustrates an example implementation with an integrated uncertainty quantification (UQ) module 920 which provides uncertainty estimates for RTL code snippets 910 at an earlier stage, allowing a user to intervene before the synthesis process. In particular, the UQ module 920 identifies low uncertainty samples 935 and high uncertainty samples 930. The low uncertainty samples 935 can be sent to the synthesis tool 940 to continue without human intervention with a high probability of success. In contrast, the high uncertainty samples 930 (e.g., which may include hallucinated code) are inspected by the designer prior to the time-consuming synthesis operations performed by the synthesis tool 940.

By using the uncertainty quantification (UQ) module 920 adapted for RTL code, model uncertainty scores can be computed ad hoc. The only requirement is to sample multiple code generations at a high temperature. From the total group of samples 910, the UQ module 920 may indicate the candidate sample (e.g., one of the low uncertainty samples 935) with the highest likelihood (log probability) and the lowest entropy as the final output from the code generator 805 for further processing in the synthesis tool 940.

In some embodiments, if the uncertainty score exceeds a threshold, τ, the code sample 930 is classified as high uncertainty and a manual inspection is triggered for review by a designer or code expert. Conversely, if the uncertainty is below τ, the code sample 935 is passed directly to the synthesizer 940, where the risk of failure is expected to be low due to a reduced likelihood of hallucinations.

In summary, integrating early-stage inspection into the code generation pipeline minimizes the risk of hallucinated RTL propagating into the synthesis stage, thereby reducing wasted computation and engineering effort. At scale, this approach can accelerate time-to-market, enhance model trustworthiness and reliability, and facilitate both explainability and principled model selection for LLM-based hardware design. The techniques described herein extend semantic uncertainty estimation to code generation tasks, addressing the key limitations of applying language-based techniques to code. Clustering strategies suitable for code and alternatives to textual entailment models are implemented by leveraging the syntactical, functional, and semantic meaning of the code. For semantic meaning, code judge models are used, which are evaluators that assess both syntactical and functional equivalence. Some embodiments are also applied to RTL (Register Transfer Level) code generation, a critical component in agentic hardware development.

Detailed below are descriptions of exemplary computer and processor architectures on which the embodiments described herein may be implemented. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

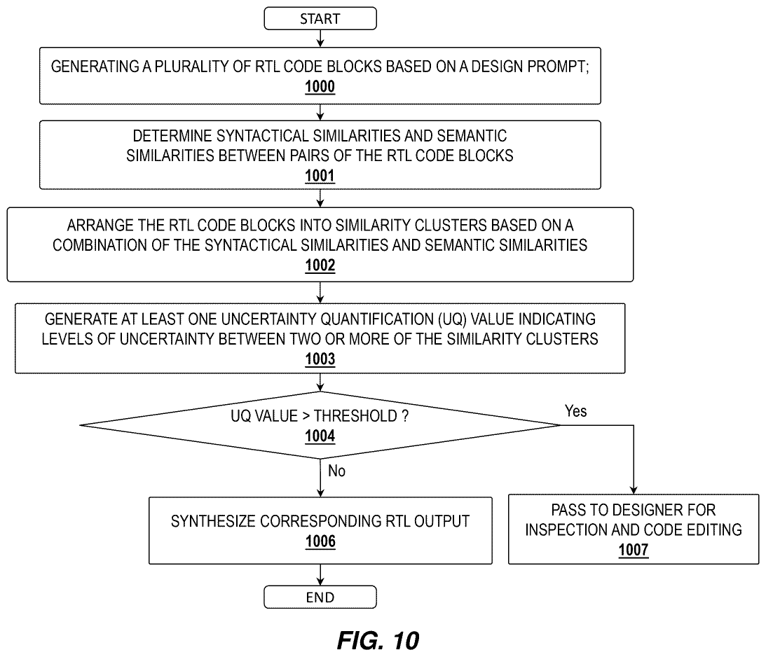

FIG. 10 illustrates a method in accordance with some embodiments of this disclosure. The method may be implemented on the architecture described herein, but is not limited to any particular processor or system architecture.

At 1000, a plurality of RTL code blocks are generated based on a design prompt. For example, a design prompt requesting the generation of RTL code may be submitted to an LLM configured to generate the plurality of RTL code blocks.

At 1001, syntactical similarities and semantic similarities (e.g., functional similarities) between pairs of the RTL code blocks are determined. A syntactical similarity may include, for example, a measure of how much the two code blocks look the same with respect to text and code structure. Semantic similarities can include, for example, a measure indicating the extent to which the two code blocks share the same meaning, intent, or concept. Semantic similarities may also include functional similarities which are measures of the extent to which any two code blocks yield the same output in response to the same input.

At 1002, the RTL code blocks are arranged into similarity clusters based on a combination of the syntactical similarities and semantic similarities. For example, two code blocks for which a calculated syntactical similarity metric and a semantic similarity metric are both above specified thresholds may be included in the same cluster.

At 1003, at least one uncertainty quantification (UQ) value is generated to indicate a level of uncertainty between at least two of the similarity clusters. If this UQ value is above a threshold, determined at 1004, then the results are passed to a designer for inspection and code editing at 1007 (e.g., because this level of uncertainty means that the corresponding RTL code is incorrect and may include hallucinations). If the UQ value is below the threshold at 1004, then at 1006, the corresponding RTL output is synthesized by a synthesis tool 940.

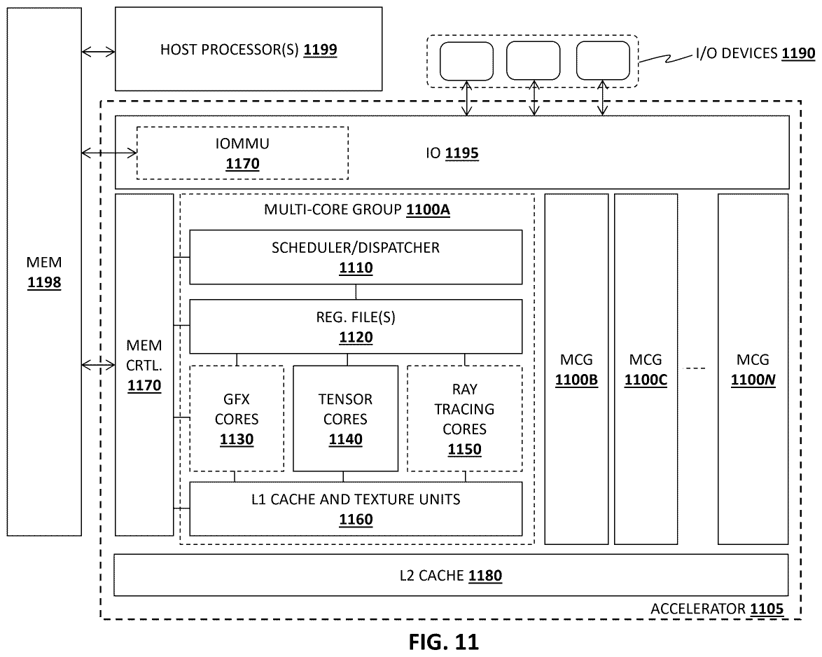

FIG. 11 illustrates an example system on which the embodiments of this disclosure may be implemented. One or more host processors 1199 and an accelerator 1105 (e.g., a graphics processor or AI accelerator) are coupled to a memory 1198. The accelerator 1105 includes dedicated sets of processing resources arranged into multi-core groups 1100A-N, each of which may include a set of tensor cores 1140 and, optionally, a set of graphics cores 1130 and ray tracing cores 1150. In implementations in which the accelerator 1105 functions as both a graphics processor and an AI accelerator, the multi-core groups 1100A may include the graphics cores 1130 and/or ray tracing cores 1150 in addition to the tensor cores 1140. Alternatively, when the accelerator 1105 is a dedicated AI accelerator (i.e., not intended for graphics operations), each multi-core group may include various forms of tensor cores 1140 for performing tensor operations required by AI kernels (e.g., kernels for implementing the various LLM models described herein).

A scheduler/dispatcher 1110 schedules and dispatches threads for execution on the various cores 1130, 1140, 1150. A set of register files 1120 store operand values used by the cores 1130, 1140, 1150 when executing the graphics threads. These may include, for example, integer registers for storing integer values, floating point registers for storing floating point values, vector registers for storing packed data elements (integer and/or floating point data elements) and tile registers for storing tensor/matrix values. The tile registers may be implemented as combined sets of vector registers.

One or more Level 1 (L1) caches and texture units 1160 store data such as tensor data, texture data, vertex data, pixel data, ray data, bounding volume data, etc, locally within each multi-core group 1100A. A Level 2 (L2) cache 1180 shared by all or a subset of the multi-core groups 1100A-N stores data and/or instructions for multiple concurrent threads. As illustrated, the L2 cache 1180 may be shared across a plurality of multi-core groups 1100A-N. One or more memory controllers 1170 couple the accelerator 1105 to a memory 1198 which may be a system memory (e.g., DRAM) and/or a local device memory (e.g., GDDR6 or HBM memory).

Input/output (IO) circuitry 1195 couples the accelerator 1105 to one or more IO devices 1195 such as digital signal processors (DSPs), network controllers, or user input devices. An on-chip interconnect may be used to couple the I/O devices 1190 to the accelerator 1105 and memory 1198. One or more IO memory management units (IOMMUs) 1170 of the IO circuitry 1195 couple the IO devices 1190 directly to the system memory 1198. The IOMMU 1170 may manage multiple sets of page tables to map virtual addresses to physical addresses in system memory 1198. Additionally, the IO devices 1190, CPU(s) 1199, and GPU(s) 1105 may share the same virtual address space.

The IOMMU 1170 may also support virtualization. In this case, it may manage a first set of page tables to map guest/graphics virtual addresses to guest/graphics physical addresses and a second set of page tables to map the guest/graphics physical addresses to system/host physical addresses (e.g., within system memory 1198). The base addresses of each of the first and second sets of page tables may be stored in control registers and swapped out on a context switch (e.g., so that the new context is provided with access to the relevant set of page tables). While not illustrated in FIG. 11, each of the cores 1130, 1140, 1150 and/or multi-core groups 1100A-N may include translation lookaside buffers (TLBs) to cache guest virtual to guest physical translations, guest physical to host physical translations, and guest virtual to host physical translations.

The CPUs 1199, accelerators 1105, and IO devices 1190 can be integrated on a single semiconductor chip and/or chip package. The illustrated memory 1198 may be integrated on the same chip or may be coupled to the memory controllers 1170 via an off-chip interface. In one implementation, the memory 1198 comprises GDDR6 memory which shares the same virtual address space as other physical system-level memories, although the underlying principles of this disclosure are not limited to this specific implementation.

The tensor cores 1140 may include a plurality of execution units specifically designed to perform matrix operations, which are the fundamental compute operation used to perform deep learning operations. For example, simultaneous matrix multiplication operations may be used for neural network training and inferencing. The tensor cores 1140 may perform matrix processing using a variety of operand precisions including single precision floating-point (e.g., 32 bits), half-precision floating point (e.g., 16 bits), integer words (16 bits), bytes (8 bits), and half-bytes (4 bits). A neural network implementation may also extract features of each rendered scene, potentially combining details from multiple frames, to construct a high-quality final image.

In deep learning implementations, parallel matrix multiplication work may be scheduled for execution on the tensor cores 1140. The training of neural networks, in particular, requires a significant number matrix dot product operations. In order to process an inner-product formulation of an N×N×N matrix multiply, the tensor cores 1140 may include at least N dot-product processing elements. Before the matrix multiply begins, one entire matrix is loaded into tile registers and at least one column of a second matrix is loaded each cycle for N cycles. Each cycle, there are N dot products that are processed. Matrix elements may be stored at different precisions depending on the particular implementation, including 16-bit words, 8-bit bytes (e.g., INT8) and 4-bit half-bytes (e.g., INT4). Different precision modes may be specified for the tensor cores 1140 to ensure that the most efficient precision is used for different workloads (e.g., such as inferencing workloads which can tolerate quantization to bytes and half-bytes).

### Examples

The following are example implementations of different embodiments of the invention.

Example 1. A machine-readable medium having program code stored thereon which, when executed by one or more processors, is to cause the one or more processors to perform operations, comprising: generating, by a large language model (LLM) code generator, a plurality of RTL code blocks based on a design prompt; determining syntactical similarities and semantic similarities between pairs of the RTL code blocks; arranging the RTL code blocks into a plurality of clusters based on a combination of the syntactical similarities and the semantic similarities; generating uncertainty estimates indicating levels of uncertainty associated with one or more clusters of the plurality of clusters; and determining whether to synthesize an RTL output using one or more of the RTL code blocks based on the uncertainty estimates.

Example 2. The machine-readable medium of Example 1, wherein a syntactical similarity between a pair of the RTL code blocks comprises a measure of how much the two code blocks look the same with respect to text and code structure and a semantic similarity comprises a measure of the extent to which the two code blocks share the same meaning, intent, concept, or functionality.

Example 3. The machine-readable medium of Example 2, wherein the semantic similarity incorporates a measurement of functional similarity generated based on an extent to which the two code blocks yield an equivalent output in response to an equivalent input.

Example 4. The machine-readable medium of Example 3, further comprising program code to cause the one or more processors to perform operations, comprising: executing the two code blocks with test bench specifications to determine the measurement of functional similarity, wherein the two code blocks are determined to be functionally equivalent if, when executed with the test bench specifications, the two code blocks yield the equivalent output and generate equivalent errors in response to the equivalent input.

Example 5. The machine-readable medium of Example 1, wherein a first RTL code block and a second RTL code block are included in a first cluster of the plurality of clusters if a syntactical similarity metric indicating a level of syntactical similarity and a semantic similarity metric indicating a level of semantic similarity are greater than one or more defined similarity thresholds.

Example 6. The machine-readable medium of Example 1, further comprising program code to cause the one or more processors to perform operations, comprising: automatically submitting a first RTL code block to synthesize a first RTL output when a first uncertainty estimate associated with the first RTL code block is above a defined uncertainty threshold.

Example 7. The machine-readable medium of Example 6, further comprising program code to cause the one or more processors to perform operations, comprising: automatically submitting a second RTL code block for review by a designer before allowing the second RTL code block to be submitted to synthesize the second RTL output when a second uncertainty estimate associated with the second RTL code block is below the defined uncertainty threshold.

Example 8. A system comprising a memory to store program code and one or more processors to process the program code to implement a semantic uncertainty framework for automated register-transfer level (RTL) code generation, the semantic uncertainty framework comprising: a large language model (LLM) code generator to generate a plurality of RTL code blocks based on a design prompt; evaluator logic to determine syntactical similarities and semantic similarities between pairs of the RTL code blocks; clustering logic to arrange the RTL code blocks into a plurality of clusters based on a combination of the syntactical similarities and the semantic similarities; uncertainty quantification logic to generate uncertainty estimates indicating levels of uncertainty associated with one or more clusters of the plurality of clusters; and determining whether to synthesize an RTL output using one or more of the RTL code blocks based on the uncertainty estimates.

Example 9. The system of Example 8, wherein a syntactical similarity between a pair of the RTL code blocks comprises a measure of how much the two code blocks look the same with respect to text and code structure and a semantic similarity comprises a measure of the extent to which the two code blocks share the same meaning, intent, concept, or functionality.

Example 10. The system of Example 9, wherein the semantic similarity incorporates a measurement of functional similarity based on whether the two code blocks yield an equivalent output in response to an equivalent input.

Example 11. The system of Example 10, wherein the semantic uncertainty framework further comprises: test bench specifications to be applied to the two code blocks to determine the measurement of functional similarity, wherein the two code blocks are determined to be functionally equivalent if, when executed with the test bench specifications, the two code blocks yield the equivalent output and generate equivalent errors in response to the equivalent input.

Example 12. The system of Example 8, wherein the clustering logic is to include a first RTL code block and a second RTL code block in a first cluster of the plurality of clusters if a syntactical similarity metric indicating a level of syntactical similarity and a semantic similarity metric indicating a level of semantic similarity are greater than one or more defined similarity thresholds.

Example 13. The system of Example 8, wherein a first RTL code block is to automatically be submitted to synthesize a first RTL output when a first uncertainty estimate associated with the first RTL code block is above a defined uncertainty threshold.

Example 14. The system of Example 13, wherein a second RTL code block is not automatically submitted to synthesize a second RTL output when a second uncertainty estimate associated with the second RTL code block is below the defined uncertainty threshold.

Example 15. The system of Example 14, wherein the second RTL code block is automatically submitted for review by a designer before submission to synthesize the second RTL output.

Example 16. A method, comprising: generating, by a large language model (LLM) code generator, a plurality of RTL code blocks based on a design prompt; determining syntactical similarities and semantic similarities between pairs of the RTL code blocks; arranging the RTL code blocks into a plurality of clusters based on a combination of the syntactical similarities and the semantic similarities; generating uncertainty estimates indicating levels of uncertainty associated with one or more clusters of the plurality of clusters; and determining whether to synthesize an RTL output using one or more of the RTL code blocks based on the uncertainty estimates.

Example 17. The method of Example 16, wherein a syntactical similarity between a pair of the RTL code blocks comprises a measure of how much the two code blocks look the same with respect to text and code structure and a semantic similarity comprises a measure of the extent to which the two code blocks share the same meaning, intent, concept, or functionality.

Example 18. The method of Example 17, wherein the semantic similarity incorporates a measurement of functional similarity based on whether the two code blocks yield an equivalent output in response to an equivalent input.

Example 19. The method of Example 18, further comprising: executing the two code blocks with test bench specifications to determine the measurement of functional similarity, wherein the two code blocks are determined to be functionally equivalent if, when executed with the test bench specifications, the two code blocks yield the equivalent output and generate equivalent errors in response to the equivalent input.

Example 20. The method of Example 16, wherein a first RTL code block and a second RTL code block are included in a first cluster of the plurality of clusters if a syntactical similarity metric indicating a level of syntactical similarity and a semantic similarity metric indicating a level of semantic similarity are greater than one or more defined similarity thresholds.

Embodiments of this disclosure may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment may be implemented using different combinations of software, firmware, and/or hardware.

Throughout this detailed description, for the purposes of explanation, numerous specific details were set forth in order to provide a thorough understanding of the present disclosure. It will be apparent, however, to one skilled in the art that these embodiments may be practiced without some of these specific details. In certain instances, well known structures and functions were not described in elaborate detail in order to avoid obscuring the subject matter of the present disclosure. Accordingly, the scope and spirit of the invention should be judged in terms of the claims which follow.

What is claimed is:

1. A machine-readable medium having program code stored thereon which, when executed by one or more processors, is to cause the one or more processors to perform operations, comprising:
generating, by a large language model (LLM) code generator, a plurality of register-transfer level (RTL) code blocks based on a design prompt;
determining syntactical similarities and semantic similarities between pairs of the RTL code blocks;
arranging the RTL code blocks into a plurality of clusters based on a combination of the syntactical similarities and the semantic similarities;
generating uncertainty estimates indicating levels of uncertainty associated with one or more clusters of the plurality of clusters; and
determining whether to synthesize an RTL output using one or more of the RTL code blocks based on the uncertainty estimates.

2. The machine-readable medium of claim 1, wherein a syntactical similarity between a pair of the RTL code blocks comprises a measure of how much the two code blocks look the same with respect to text and code structure and a semantic similarity comprises a measure of the extent to which the two code blocks share the same meaning, intent, concept, or functionality.

3. The machine-readable medium of claim 2, wherein the semantic similarity incorporates a measurement of functional similarity generated based on an extent to which the two code blocks yield an equivalent output in response to an equivalent input.

4. The machine-readable medium of claim 3, further comprising program code to cause the one or more processors to perform operations, comprising:
executing the two code blocks with test bench specifications to determine the measurement of functional similarity, wherein the two code blocks are determined to be functionally equivalent if, when executed with the test bench specifications, the two code blocks yield the equivalent output and generate equivalent errors in response to the equivalent input.

5. The machine-readable medium of claim 1, wherein a first RTL code block and a second RTL code block are included in a first cluster of the plurality of clusters if a syntactical similarity metric indicating a level of syntactical similarity and a semantic similarity metric indicating a level of semantic similarity are greater than one or more defined similarity thresholds.

6. The machine-readable medium of claim 1, further comprising program code to cause the one or more processors to perform operations, comprising:
submitting a first RTL code block to synthesize a first RTL output when a first uncertainty estimate associated with the first RTL code block is above a defined uncertainty threshold.

7. The machine-readable medium of claim 6, further comprising program code to cause the one or more processors to perform operations, comprising:
submitting a second RTL code block for review by a designer before allowing the second RTL code block to be submitted to synthesize the second RTL output when a second uncertainty estimate associated with the second RTL code block is below the defined uncertainty threshold.

8. A system comprising a memory to store program code and one or more processors to process the program code to implement a semantic uncertainty framework for automated register-transfer level (RTL) code generation, the semantic uncertainty framework comprising:
a large language model (LLM) code generator to generate a plurality of RTL code blocks based on a design prompt;
evaluator logic to determine syntactical similarities and semantic similarities between pairs of the RTL code blocks;
clustering logic to arrange the RTL code blocks into a plurality of clusters based on a combination of the syntactical similarities and the semantic similarities;
uncertainty quantification logic to generate uncertainty estimates indicating levels of uncertainty associated with one or more clusters of the plurality of clusters; and
determining whether to synthesize an RTL output using one or more of the RTL code blocks based on the uncertainty estimates.

9. The system of claim 8, wherein a syntactical similarity between a pair of the RTL code blocks comprises a measure of how much the two code blocks look the same with respect to text and code structure and a semantic similarity comprises a measure of the extent to which the two code blocks share the same meaning, intent, concept, or functionality.

10. The system of claim 9, wherein the semantic similarity incorporates a measurement of functional similarity based on whether the two code blocks yield an equivalent output in response to an equivalent input.

11. The system of claim 10, wherein the semantic uncertainty framework further comprises:
test bench specifications to be applied to the two code blocks to determine the measurement of functional similarity, wherein the two code blocks are determined to be functionally equivalent if, when executed with the test bench specifications, the two code blocks yield the equivalent output and generate equivalent errors in response to the equivalent input.

12. The system of claim 8, wherein the clustering logic is to include a first RTL code block and a second RTL code block in a first cluster of the plurality of clusters if a syntactical similarity metric indicating a level of syntactical similarity and a semantic similarity metric indicating a level of semantic similarity are greater than one or more defined similarity thresholds.

13. The system of claim 8, wherein a first RTL code block is to be submitted to synthesize a first RTL output when a first uncertainty estimate associated with the first RTL code block is above a defined uncertainty threshold.

14. The system of claim 13, wherein a second RTL code block is not submitted to synthesize a second RTL output when a second uncertainty estimate associated with the second RTL code block is below the defined uncertainty threshold.

15. The system of claim 14, wherein the second RTL code block is automatically submitted for review by a designer before submission to synthesize the second RTL output.

16. A method, comprising:
generating, by a large language model (LLM) code generator, a plurality of RTL code blocks based on a design prompt;
determining syntactical similarities and semantic similarities between pairs of the RTL code blocks;
arranging the RTL code blocks into a plurality of clusters based on a combination of the syntactical similarities and the semantic similarities;
generating uncertainty estimates indicating levels of uncertainty associated with one or more clusters of the plurality of clusters; and
determining whether to synthesize an RTL output using one or more of the RTL code blocks based on the uncertainty estimates.

17. The method of claim 16, wherein a syntactical similarity between a pair of the RTL code blocks comprises a measure of how much the two code blocks look the same with respect to text and code structure and a semantic similarity comprises a measure of the extent to which the two code blocks share the same meaning, intent, concept, or functionality.

18. The method of claim 17, wherein the semantic similarity incorporates a measurement of functional similarity based on whether the two code blocks yield an equivalent output in response to an equivalent input.

19. The method of claim 18, further comprising:
executing the two code blocks with test bench specifications to determine the measurement of functional similarity, wherein the two code blocks are determined to be functionally equivalent if, when executed with the test bench specifications, the two code blocks yield the equivalent output and generate equivalent errors in response to the equivalent input.

20. The method of claim 16, wherein a first RTL code block and a second RTL code block are included in a first cluster of the plurality of clusters if a syntactical similarity metric indicating a level of syntactical similarity and a semantic similarity metric indicating a level of semantic similarity are greater than one or more defined similarity thresholds.
